(19) United States
(12) Patent Application Publication
(10) Pub. No.: US 2013/0218625 A1
(43) Pub. Date: Aug. 22, 2013

(54) UTILIZING HISTORIC PROJECTS TO ESTIMATE A NEW PROJECT SCHEDULE BASED ON USER PROVIDED HIGH LEVEL PARAMETERS

(71) Applicants: MARK DUQUETTE, LEXINGTON, MA (US); SRI VYTHESWARAN, LEXINGTON, MA (US); KEVIN J. WILLIAMS, LEXINGTON, MA (US)

(72) Inventors: MARK DUQUETTE, LEXINGTON, MA (US); SRI VYTHESWARAN, LEXINGTON, MA (US); KEVIN J. WILLIAMS, LEXINGTON, MA (US)

(73) Assignee: INTERNATIONAL BUSINESS MACHINES CORPORATION, ARMONK, NY (US)

(21) Appl. No.: 13/401,913

(22) Filed: Feb. 22, 2012

(51) Int. Cl. G06Q 10/06

(52) U.S. Cl. 705/7.23

(57) ABSTRACT

A data warehouse for historic projects can be maintained and can include different artifacts per project, human and organizational resources consumed, intra-artifact temporal dependencies, and timelines. A set of parameters for a new project can be received which can define a scope of the new project at a level of abstraction above an artifact level. Key artifacts and stages needed for completing the project can be established which can be consistent with the set of parameters. Two or more historic projects can be determined to have artifacts/stages similar to the key artifacts/stages of the project. A data driven heuristic algorithms can estimate timelines for producing the key artifacts and the stages based on artifact level data for the historic projects can be executed. A schedule for the project can be generated which can break down the project by the stages and the key artifacts and provide the estimated timelines.

### BACKGROUND

The present invention relates to the field of project planning and, more particularly, to utilizing historic projects to estimate a new project schedule based on user provided high level parameters.

Software development frequently utilizes project management to aid in sophisticated and complex processes (e.g., product development, testing, etc). Project management can employ planning, organizing, securing, and managing resources to bring about the successful completion of specific project goals and objectives. Software development effort estimation can predict the most realistic use of effort required to develop or maintain software based on incomplete, uncertain, and/or “noisy” inputs. Effort estimates can be used as input to project plans, iteration plans, budgets, investment analyses, pricing processes. That is, effort estimation is a key part of project execution and can be utilized to reduce risk, improve project success, and meet business objectives.

Project managers can currently produce product development schedules by drawing on information from disparate sources including prior personal experience, circumstantial information, and sometimes manual assessment of data from related projects. That is, managers often employ expert estimation techniques to develop a schedule. This traditional approach to product development schedule can be ad hoc, unrepeatable, and error-prone. For example, factors that have been demonstrated to affect estimation and skew results are wishful thinking, anchoring, planning fallacy, and cognitive dissonance. Other approaches such as formal estimation can be very inaccurate when the model utilized is not tailored to a particular organization context. Formal estimation frequently relies on project implementation details to provide forecasting. However, when a new project lacking implementation details requires estimation, project managers are forced to use expert estimation which has many shortcomings.

### BRIEF SUMMARY

One aspect of the present invention can include a system, an apparatus, a computer program product, and a method for utilizing historic projects to estimate a new project schedule based on user provided high level parameters. A data warehouse for historic projects can be maintained. The data warehouse can include one or more different artifacts per project, human and organizational resources consumed while producing each of the different artifacts, intra-artifact temporal dependencies, and timelines for producing each of the artifacts. A set of parameters for a new project can be received. The parameters can define a scope of the new project at a level of abstraction above an artifact level. A set of key artifacts and stages needed for completing the new project can be established. The set of key artifacts and stages can be consistent with the set of parameters. A set of two or more historic projects having data that is maintained in the data warehouse can be determined. The two or more historic projects can have one or more artifacts similar to one of the key artifacts or have one or more stages similar to one of the stages of the new project. One or more data driven heuristic algorithms can estimate timelines for producing the key artifacts and the stages of the new project based on artifact level data stored in the data warehouse for the two or more historic projects can be executed. A schedule for the new project can be generated. The schedule can break down the new project by the stages and the key artifacts and provides the estimated timelines.

Another aspect of the present invention can include an apparatus, a computer program product, a method, and a system for utilizing historic projects to estimate a new project schedule based on user provided high level parameters. A set of high level parameters can be received as user input for a new project. A data warehouse maintaining records for one or more historic projects can be queried to determine a subset of the historic projects having statistically defined strong similarities to the new project. The strong similarities can be based on a correspondence between the set of high level parameters and details of the subset of the historic projects. A schedule for the new project having one or more stages can be generated. The one or more artifacts can be generated in the stages. The stages and the artifacts can lack definition provided by the user input, the high level parameters, or by any other manual input entered for the new project. The stages and artifacts can be heuristically determined from specifics maintained in the data warehouse for the subset of historic projects. The schedule can detail timelines for each of the stages and artifacts. The timelines can be heuristically determined in a data driven manner from data of the subset of historic projects.

### BRIEF DESCRIPTION OF THE SEVERAL VIEWS OF THE DRAWINGS

FIG. 1 is a schematic diagram illustrating a method for utilizing historic projects to estimate a new project schedule based on user provided high level parameters in accordance with an embodiment of the inventive arrangements disclosed herein.

FIG. 2 is a schematic diagram illustrating a system for utilizing historic projects to estimate a new project schedule based on user provided high level parameters in accordance with an embodiment of the inventive arrangements disclosed herein.

FIG. 3 is a schematic diagram illustrating an interface utilizing historic projects to estimate a new project schedule based on user provided high level parameters in accordance with an embodiment of the inventive arrangements disclosed herein.

### DETAILED DESCRIPTION

The present disclosure is a solution for project schedule estimation utilizing historic project artifact metadata. In the solution, historical project data (e.g., artifacts) can be federated into a common data warehouse. High level parameters (e.g., provided by a user) can be associated with a new project. The parameters can be utilized to establish one or more key artifacts and/or stages. Historic project data with artifacts similar to key artifacts and/or stages can be identified. The historic project data can be evaluated by a heuristic algorithm which can generate timelines for each key artifact and/or stage. The generated timelines can be utilized to generate a schedule for the new project.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

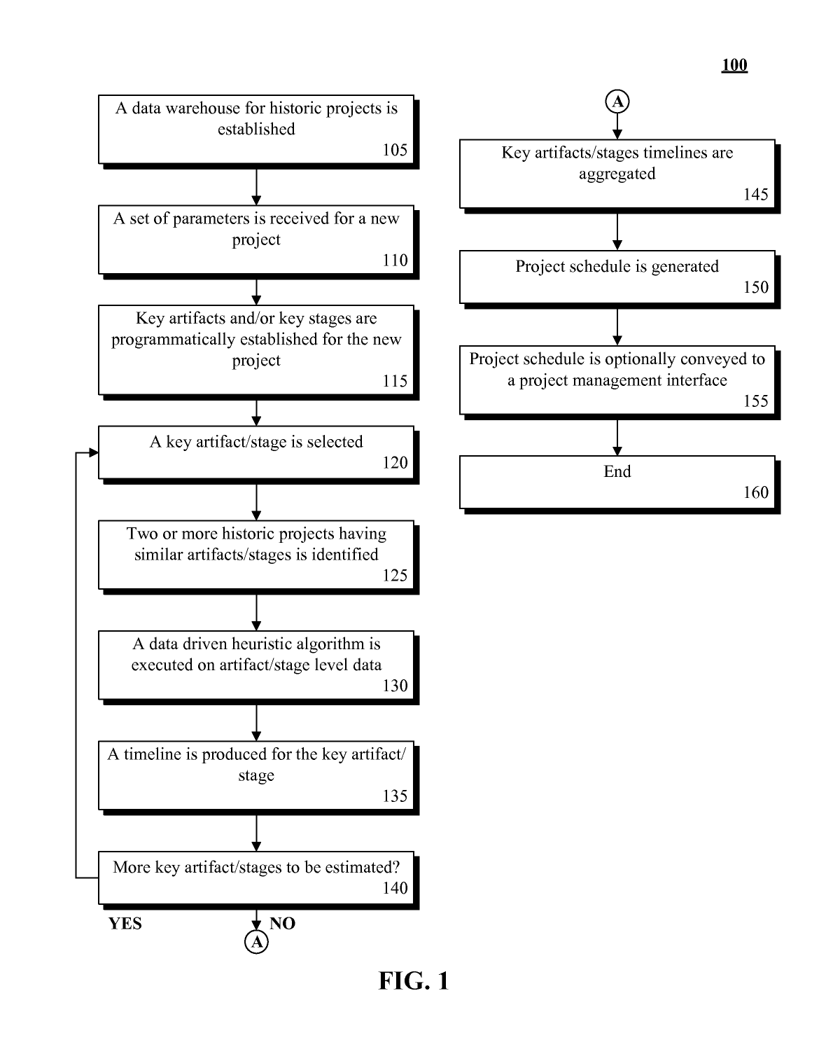

FIG. 1 is a schematic diagram illustrating a method 100 for utilizing historic projects to estimate a new project schedule based on user provided high level parameters in accordance with an embodiment of the inventive arrangements disclosed herein. Method 100 can be performed in the context of system 200 and/or interface 310, 340. In method 100, a set of high level parameters for a new software development project can be provided by a user. The parameters can be automatically correlated to key artifacts and stages which are relevant to planning, organizing, and managing (e.g., completing) the new project. The key artifacts/stages can be utilized to search a historic project repository for similar historic artifacts/stages. A heuristic algorithm can evaluate each historic artifact and/or historic stage to determine an approximate timeline for the new project key artifacts and/or key stages. The timelines can be employed to produce a schedule for the new project. The schedule can be evaluated/reviewed by relevant personnel to aid in new project completion.

As used herein, a new project can refer to a temporary or semi-permanent functional work to produce a product and/or service. For instance, the new project can be a software application development project. The new project can have defined constraints. Constraints can include, but is not limited to, a scope, a time (e.g., a date), a budget, a deliverable, and the like. High level parameters can be limitations which do not explicitly define any key artifacts and/or key artifact specifics for the new project. The schedule can be a timetable which explicitly define a set of key artifacts and key artifact specifics for the new project. It should be appreciated that the disclosure can assist project managers with the planning and design phase of a project through schedule development.

In step 105, a data warehouse for historic projects can be established. The data warehouse can be established automatically and/or manually through traditional and/or proprietary mechanisms. In step 110, a set of parameters can be received for a new project. For example, a set of parameters can be defined by a project manager within a project management interface. In step 115, key artifacts and/or key stages can be programmatically established for the new project. Key artifacts and/or key stages can be established automatically utilizing parameters and/or other convention or non-conventional inputs. In one embodiment, a project template can be utilized to determine key artifacts and/or key stages. In another embodiment, key artifacts can be heuristically established.

In step 120, a key artifact/stage associated with the new project can be selected. Selection can be based on one or more criteria including, but not limited to, priority, name, owner, and the like. For example, key stages with high priority can be selected before stages with lower priorities. In step 125, two or more historic projects having strong similar historic artifacts/stages can be identified. Historic projects can be identified utilizing traditional and/or proprietary mechanism. In one embodiment, one or more properties can be associated with the key artifact/stage. In the embodiment, the properties can be evaluated against properties associated with historic artifact/stages of the historic projects. That is, similarity determination can be arbitrarily complex permitting simple pattern matching to sophisticated content/metadata evaluation.

In step 130, a data driven heuristic algorithm can be executed on the historic artifact/stage level data. The algorithm can conform to traditional and/or proprietary data driven heuristic algorithms. In step 135, a timeline can be produced for the key artifact/stage. In step 140, if more key artifact/stages are to be estimated, the method can return to step 120, else continue to step 145. The method can continuously repeat for each key artifact/stage allowing timeline creation for each relevant entity within the new project. In step 145, key artifact/stages timelines can be aggregated. Aggregation can include, but is not limited to, resolving inter-artifact dependencies, timeline optimization, and the like. In step 150, a project schedule can be generated. In one embodiment, the schedule can include a work breakdown structure. For example, a Gantt chart of the schedule can be created. In step 155, a project schedule can be optionally conveyed to a project management interface. In step 160, the method can end.

Drawings presented herein are for illustrative purposes only and should not be construed to limit the invention in any regard. Steps 105-155 can be performed in serial or in parallel. It should be appreciated that steps 105-155 can be performed in real-time or near real-time.

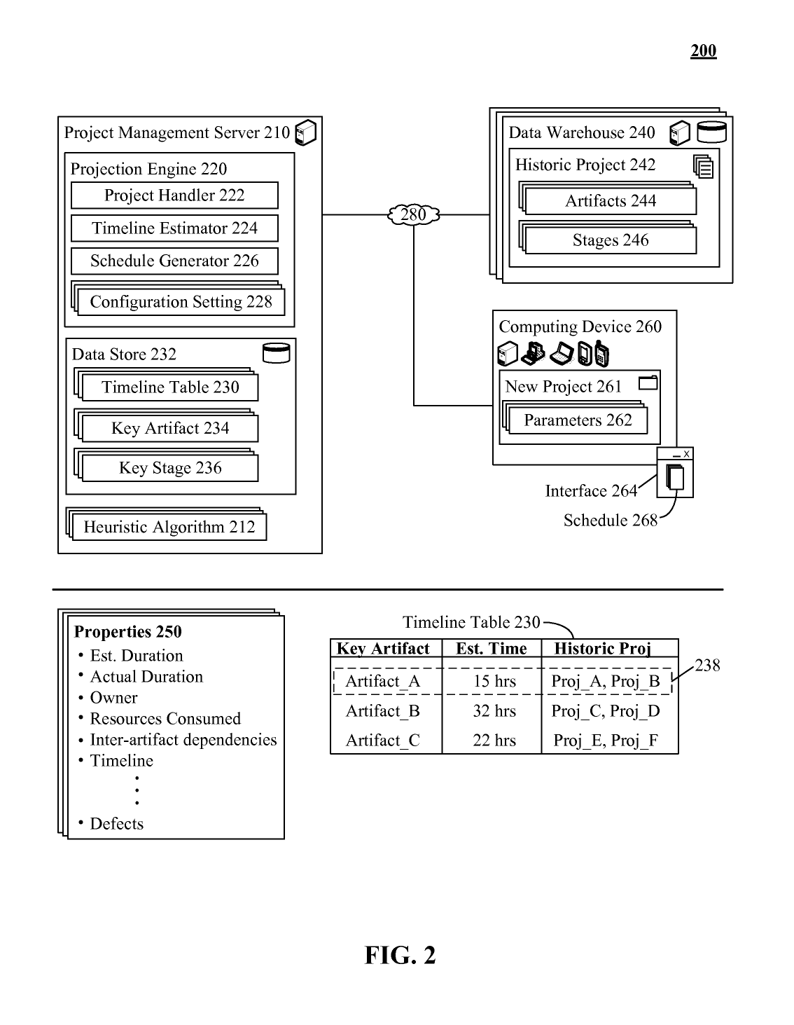

FIG. 2 is a schematic diagram illustrating a system 200 for utilizing historic projects to estimate a new project schedule based on user provided high level parameters in accordance with an embodiment of the inventive arrangements disclosed herein. System 200 can be present in the context of method 100 and/or interface 310, 340. In system 200, a projection engine 220 can provide a forecasted schedule (e.g., schedule 268) for a new project 261 based on parameters 262. Project 261 can lack key artifact and stages necessary for project completion (e.g., implementation specifics). System 200 components can be communicatively linked via network 280.

As used herein, historic project 242 can be a project which has been completed historically. Historic project 242 can include, but is not limited to, artifacts 244, stages 246 and the like. Each artifact 244 and/or stage 246 can be associated with properties 250. Properties 250 can include, but is not limited to, estimated duration, actual duration, owner, resources consumed, inter-artifact dependencies, inter-stage dependencies, timeline, defects, and the like. In one embodiment of the disclosure, effort estimation can be performed utilizing properties 250.

Project management server 210 can be a hardware/software element able to executed project engine 220. Server 210 can include, but is not limited to projection engine 220, heuristic algorithm 212, data store 232, and the like. Server 210 functionality can include, project planning, project management, project organization, project data storage, and the like. Server 210 can be a distributed computing element, networked computing element, and the like. In one instance, server 210 can be associated with an IBM RATIONAL software.

Projection engine 220 can be a hardware/software component able to heuristically generate a schedule 268 based on parameters 262. Engine 220 can include, but is not limited to, project handler 222, timeline estimator 224, schedule generator 226, configuration setting 228, and the like. Engine 220 functionality can include, but is not limited to, authentication, encryption/decryption, optimization, budgeting estimation, and the like. Engine 220 can be a distributed component, a networked component, and the like. In one embodiment, engine 220 can be a component of a Service Oriented Architecture. In the embodiment, engine 220 can be a Web-enabled service.

Project handler 222 can be a hardware/software entity able to determine key artifacts and/or stages associated with parameters 262. Handler 222 functionality can include, but is not limited to, historic project identification, historic project analysis, historic artifact/stage selection, property 250 evaluation, and the like. In one embodiment, handler 222 can identify similar artifacts 244 and/or stages 246 associated with a new project 261. In the embodiment, handler 222 can utilize one or more rulesets and/or threshold values to determine similarity. For example, handler 222 can utilize properties 250 to determine a strong similarity between artifact 244 to key artifact 234.

Timeline estimator 244 can be a hardware/software element for heuristically determining key artifact 234 and/or key stage 236 timeline. Estimator 244 functionality can include, but is not limited to, property 250 analysis, timeline generation, and the like. In one embodiment, estimator 244 can utilize heuristic algorithm 212 to generate timeline timetable 230 for each key artifact 234 and/or key stage 236. In the embodiment, estimator 244 can create timeline table 230 which can be utilized to establish schedule 268.

Schedule generator 226 can be a hardware/software component for creating schedule 268. Generator 226 functionality can include, but is not limited to, timeline optimization, timeline aggregation, and the like. Generator 226 can employ parameters 262, external parameters (not shown), and/or timeline table 230 to create schedule 268. For example, generator 226 can factor in the skill level of various team members to approximate a schedule 268. In one embodiment, generator 226 can utilize heuristic algorithm 212 to establish schedule 268.

Configuration setting 228 can be one or more ruleset for configuring the behavior of engine 220 and/or system 200. Setting 228 can include, but is not limited to, project handler 222 settings, time estimator 224 options, schedule generator 226 parameters, timeline table 230, data store 232, heuristic algorithm 212, and the like. Setting 228 can be manually and/or automatically determined. In one instance, setting 228 can be configured via interface 264.

Data store 232 can be a hardware/software component able to persist timeline table 230, key artifact 234, and/or key stage 236. Data store 232 can be a Storage Area Network (SAN), Network Attached Storage (NAS), and the like. Data store 232 can conform to a relational database management system (RDBMS), object oriented database management system (OODBMS), and the like. Data store 232 can be communicatively linked to server 210 in one or more traditional and/or proprietary mechanisms. In one instance, data store 232 can be a component of data warehouse 240.

Timeline table 230 can be a data set including key artifact and/or stage timeline computation. Table 230 can include, but is not limited to, key artifact identifier, estimated timeline, historic projects utilized to create timeline, and the like. For example, in entry 238, a key artifact (e.g., Artifact_A) can be estimated to have a duration of fifteen hours based on similar artifacts within historic projects (e.g., Proj_A, Proj_B). It should be understood that timeline within entry 238 can be arbitrarily complex. For example, timeline can be a computed value in hours or can be a graphic representation of a sequence of events and associated durations.

Key artifact 234 can be one or more project artifacts necessary for completing project 261. In one instance, artifact 234 can be a software development artifact. In the instance, the artifact 234 can include, but is not limited to, requirements analysis, data flow diagrams, documentation, and the like. It should be appreciated that key artifacts 234 can be a placeholder element and can lack implementation specifics.

Key stage 236 can be one or more project stages necessary for completing project 261. In one embodiment, stage 236 can be a software development stage. In the instance, stage 236 can include, but is not limited to, design, implementation, testing, and the like. It should be appreciated that key stage 236 can be a placeholder stage element and can lack implementation specifics.

Heuristic algorithm 212 can be a computer algorithm for automatically determining a project schedule 268 utilizing parameters 262. Algorithm 212 can include traditional and/or proprietary effort estimation algorithms. In one instance, algorithm 212 can produce a confidence score indicating the likelihood the schedule 268 is accurate. In another instance, algorithm 212 can utilize weighting points to estimate effort for project 261. In the instance, weighting points can be employed to evaluate test cases permitting robust functionality. For example, the number of defects associated with an artifact 244 can affect the artifact 244 contribution during estimation.

Computing device 260 can be a hardware/software entity able to create and/or define project 261 using high level parameters 262. Device 260 can include, but is not limited to, new project 261, interface 264, and the like. Device 260 can include a desktop computer, laptop, mobile phone, tablet computing device, personal digital assistant (PDA), portable computing device, and the like. Computing device 210 can be, but is not limited to, a thin client, a fat client, a hybrid client, and the like

New project 261 can be a project lacking implementation specifics (e.g., requirements documentation, test cases, etc). Project 261 can include parameters 261 which can be user specified scoping details associated with project 261. Project 261 can be associated with an integrated development environment, a project management software, and the like. Project 261 can be associated with two or more projects (e.g., multi-project effort).

Parameters 262 can be one or more high level parameters associated with project 261. Parameters 262 can include, but is not limited to, product properties, hardware properties, personnel attributes, and the like. Parameters 262 can include, but is not limited to organizational parameters (e.g., organization policies, budget), development parameters (e.g., team size, team skill level, project scope, inter-artifact dependencies, inter-stage dependencies), personnel parameters (e.g., vacation time, overtime), and the like.

Data warehouse 240 can be a hardware/software able to transparently integrate multiple autonomous database systems into a single component. Data warehouse 240 can include, but is not limited to historic project 242, warehouse 240, and the like. Data warehouse 240 can be a Storage Area Network (SAN), Network Attached Storage (NAS), and the like. Data warehouse 240 can conform to a relational database management system (RDBMS), object oriented database management system (OODBMS), and the like. In one embodiment, data warehouse 240 can be a federated databases.

Interface 264 can be a user interactive component permitting interaction and/or presentation of schedule 268. Interface 264 can be present within the context of a Web browser application, an integrated development environment (IDE), and the like. Interface 264 capabilities can include a graphical user interface (GUI), voice user interface (VUI), mixed-mode interface, and the like. Interface 264 can be communicatively linked to computing device 210.

Schedule 268 can be a effort estimation entity associated with project 261 and parameters 262. Schedule 268 can include, but is not limited to, time estimation details, budget estimation information, and the like. In one embodiment, schedule 268 can be an interactive entity permitting traceability (e.g., auditing), optimization, and the like. In one instance, schedule 268 can provide effort estimation for multiple project methodologies. In the instance, schedule 268 can include estimations for multiple methodologies comparing effort required for the multiple project methodologies.

Network 280 can be an electrical and/or computer network connecting one or more system 200 components. Network 280 can include, but is not limited to, twisted pair cabling, optical fiber, coaxial cable, and the like. Network 280 can include any combination of wired and/or wireless components. Network 280 topologies can include, but is not limited to, bus, star, mesh, and the like. Network 280 types can include, but is not limited to, Local Area Network (LAN), Wide Area Network (WAN), Virtual Private Network (VPN) and the like.

Drawings presented herein are for illustrative purposes only and should not be construed to limit the invention in any regard. It should be appreciated the disclosure can evaluate and forecast multiple projects 261 separately or collectively permitting individualized project schedules and/or multi-project schedules. It should be appreciated that timeline table 230 can facilitate a complete auditing trail which can be used to manually refine and/or correct schedule 268 estimation.

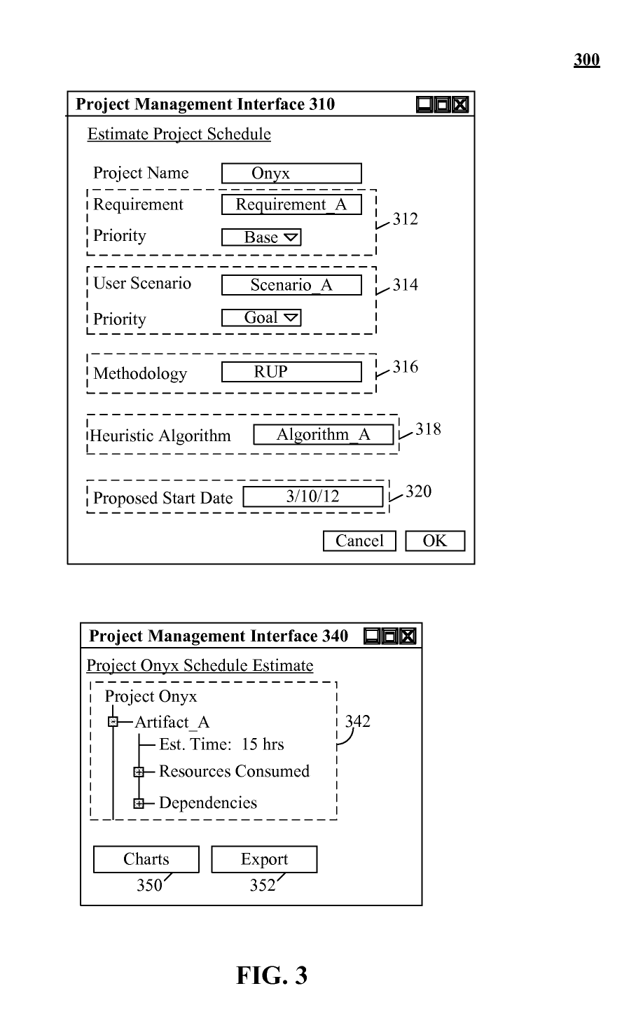

FIG. 3 is a schematic diagram illustrating an interface 310, 340 utilizing historic projects to estimate a new project schedule based on user provided high level parameters in accordance with an embodiment of the inventive arrangements disclosed herein. Interface 310, 340 can be presented in the context of method 100 and/or system 200. In interface 310, high level parameters 312-320 can be provided by a user to generate a schedule for a new project. In interface 340, a project schedule estimation can be heuristically determined and presented based on parameters 312-320. Interfaces 310, 340 can be associated with a project management system. In one instance, interfaces 310, 340 can be a screen from a project management interface. For example, interface 340 can be presented responsive to submission of information within interface 310.

In project management interface 310, high level parameters 312-320 and associated properties permit a project manager to generate a schedule for a new project. In parameter 312, a requirement and an associated property (e.g., priority) can be specified. For instance, a requirement can be configured to be a base requirement. In parameter 314, a user scenario and an associated property (e.g., priority) can be selected. For example, a user scenario can be established as a goal within the new project. In parameter 316, a development methodology can be specified permitting customized schedule creation based on organizational policies. In parameter 318, one or more heuristic algorithms can be selected for generating a project schedule. Parameter 320 can be a timing parameter allowing schedule estimation to be performed. For example, parameter 320 can be a proposed start date for a new project.

In project management interface 340, a project schedule estimate can be presented within section 342. Schedule within section 342 can include, but is not limited to, artifacts, stages, resources, dependencies, and the like. For example, section 342 can present a work breakdown structure in a hierarchal tree format. Interface 340 can include tooling which can generate charts (e.g., interface element 350), permit schedule exporting (e.g., interface element 352), and the like.

Drawings presented herein are for illustrative purposes only and should not be construed to limit the invention in any regard. Interface 310, 340 functionality can be presented within a file menu, context menu, and the like. In one embodiment, interface 310 can be a screen of a project management wizard. Interface 310, 340 elements can include, but is not limited to, drop down selection boxes, radio dialogs, interactive buttons, and the like.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1.-17. (canceled)

18. A computer program product comprising a non-transitory computer readable storage medium comprising computer usable program code embodied therewith, the computer usable program code when executed by a processor, cause the processor to:
maintain a data warehouse for historic projects, wherein said data warehouse comprises a plurality of different artifacts per project, human and organizational resources consumed while producing each of the different artifacts, intra-artifact temporal dependencies, and timelines for producing each of the artifacts;
receive a set of parameters for a new project, wherein said parameters define a scope of the new project at a level of abstraction above an artifact level;
establish a set of key artifacts and stages needed for completing the new project, where the set of key artifacts and stages are consistent with the set of parameters;
determine a set of at least two historic projects having data that is maintained in the data warehouse, wherein the at least two historic projects have at least one artifact similar to one of the key artifacts or have at least one stage similar to one of the stages of the new project;
execute at least one data driven heuristic algorithm that estimate timelines for producing the key artifacts and the stages of the new project based on artifact level data stored in the data warehouse for the at least two historic projects; and
generate a schedule for the new project, wherein the schedule breaks down the new project by the stages and the key artifacts and provides the estimated timelines.

19. The computer program product of claim 18, wherein the computer program product is a project management software, wherein the project management software is associated with an IBM RATIONAL software, as existent at a time of filing.

20. The computer program product of claim 18, wherein the computer program product is associated with software tooling, wherein the software tooling is at least one of a requirements management system, a software development system, and a quality management system.

21. The computer program product of claim 18, wherein the at least two historic projects and the new project are software development projects.

22. The computer program product of claim 18, wherein the set of parameters do not explicitly define any artifacts and artifact specifics for the new project, wherein the schedule does explicitly define a set of artifacts and artifact specifics for the new project.

23. The computer program product of claim 18, wherein the schedule comprises of a work breakdown structure.

24. The computer program product of claim 18, wherein the work breakdown structure is at least one of a Program Evaluation and Review Technique (PERT) graph, and an event chain diagram.

25. The computer program product of claim 18, wherein the heuristic algorithm is associated with at least one of a weighting value and a skill factor, wherein the weighting value is a quantitative representation of the importance of the stage or artifact in relation to the new project and the skill factor is a quantitative representation of a personnel capability.

26. The computer program product of claim 18, wherein the schedule is associated with a risk assessment profile, wherein the risk assessment profile comprises of at least one of a qualitative and quantitative risk assessment for the stages and artifacts.

27. The computer program product of claim 18, wherein the schedule comprises of an estimated development effort and a test effort.

28. The computer program product of claim 18, wherein high level parameters is associated with a priority.

29. The computer program product of claim 18, wherein the schedule is automatically updated in response to a change in the high level parameters.

30. A computer implemented system for utilizing historic projects to estimate a new project schedule based on user provided high level parameters, the system comprising:
a memory for storing data;
a processor coupled to the memory, the processor configured to:
maintain a data warehouse for historic projects, wherein said data warehouse comprises a plurality of different artifacts per project, human and organizational resources consumed while producing each of the different artifacts, intra-artifact temporal dependencies, and timelines for producing each of the artifacts;
receive a set of parameters for a new project, wherein said parameters define a scope of the new project at a level of abstraction above an artifact level;
establish a set of key artifacts and stages needed for completing the new project, where the set of key artifacts and stages are consistent with the set of parameters;
determine a set of at least two historic projects having data that is maintained in the data warehouse, wherein the at least two historic projects have at least one artifact similar to one of the key artifacts or have at least one stage similar to one of the stages of the new project;
execute at least one data driven heuristic algorithm that estimate timelines for producing the key artifacts and the stages of the new project based on artifact level data stored in the data warehouse for the at least two historic projects;
generate a schedule for the new project, wherein the schedule breaks down the new project by the stages and the key artifacts and provides the estimated timelines.

31. The computer implemented system of claim 30, wherein the at least two historic projects and the new project are software development projects.

32. The computer implemented system of claim 30, wherein the set of parameters do not explicitly define any artifacts and artifact specifics for the new project, wherein the schedule does explicitly define a set of artifacts and artifact specifics for the new project.

33. The computer implemented system of claim 30, wherein the schedule comprises of a work breakdown structure.

34. The computer implemented system of claim 30, wherein the heuristic algorithm is associated with at least one of a weighting value and a skill factor, wherein the weighting value is a quantitative representation of the importance of the stage or artifact in relation to the new project and the skill factor is a quantitative representation of a personnel capability.

35. The computer implemented system of claim 30, wherein the schedule is associated with a risk assessment profile, wherein the risk assessment profile comprises of at least one of a qualitative and quantitative risk assessment for the stages and artifacts.

36. The computer implemented system of claim 30, wherein high level parameters is associated with a priority.

37. The computer implemented system of claim 30, wherein the schedule is automatically updated in response to a change in the high level parameters.
